(19) United States
(12) Patent Application Publication
(10) Pub. No.: US 2008/0188253 A1
(43) Pub. Date: Aug. 7, 2008

(54) METHOD AND SYSTEM FOR WIRELESS DESIGN SUBJECT TO INTERFERENCE CONSTRAINTS

(75) Inventors: Chia-Chin Chong, Santa Clara, CA (US); Pedro C. Pinto, Cambridge, MA (US); Moe Z. Win, Framingham, MA (US); Fujio Watanabe, Union City, CA (US); Hiroshi Inamura, Cupertino, CA (US)

Correspondence Address: MACPHERSON KWOK CHEN & HEID LLP, 2033 GATEWAY PLACE, SUITE 400, SAN JOSE, CA, 95110, US

(73) Assignee: NTT DoCoMo, Inc.

(21) Appl. No.: 12/019,562

(22) Filed: Jan. 24, 2008

Related U.S. Application Data
(60) Provisional application No. 60/887,540, filed on Jan. 31, 2007.

(51) Int. Cl. H04B 15/00; H04B 7/00

(52) U.S. Cl. 455/504; 455/501

(57) ABSTRACT

A wireless communication system experience interference from other wireless communication networks. A method for designing wireless communication systems subject to interference is proposed based on a realistic interference model which accounts for the propagation effects introduced by the wireless environment (such as path loss, shadowing, and multipath fading), and for the spatial scattering of transmitters (using a Poisson field). The method accounts for tradeoffs between network parameters, such as signal-to-noise ratio (SNR), interference-to-noise ratio (INR), path loss exponent, spatial density of the interferers, and error probability. Advantages of this method include: 1) a unified framework for designing a wireless system, subject to cumulative interference and noise, incorporating a wide range of performance metrics; and 2) a general application that covers a broad class of wireless communication systems and channel fading distributions.

### CROSS-REFERENCE TO RELATED APPLICATIONS

The present application is related to and claims priority to U.S. provisional patent application Ser. No. 60/887,540, entitled “Method and System for Wireless Design Subject to Interference Constraints,” filed on Jan. 31, 2007. The U.S. provisional patent application is hereby incorporated by reference in its entirety.

### BACKGROUND OF THE INVENTION

1. Field of the Invention

The present invention relates to wireless communication. In particular, the present invention relates to design of a wireless communication system subject to interference constraints.

2. Discussion of the Related Arts

Various wireless network design methods to minimize interference from other networks and improve the reliability in wireless communication systems have been proposed. For example, U.S. Patent Application Publication 2005/0163042 A1, entitled “Wireless Ultra Wideband Network Having Interference Mitigation and Related Methods”, by R. D. Roberts, published on Jul. 28, 2005, discloses an ultra-wide band (UWB) system architecture with interference mitigation capabilities, but does not provide a framework for a heterogeneous network. In this regard, a heterogeneous network includes devices that belong to an independent network or use different technologies.

Cellular network designs based on Poisson field models are disclosed, for example, in the article “Performance of a Spread Spectrum Packet Radio Network Link in a Poisson Field of Interferers,” by E. Sousa, published in IEEE Trans. Inform. Theory, vol. 38, no. 6, pp. 1743-1754, November 1992 and in the article “Performance of FH SS Radio Networks with Interference Modeled as a Mixture of Gaussian and Alpha-stable Noise,” by J. Ilow, D. Hatzinakos, and A. Venetsanopoulos, published in IEEE Trans. Commun., vol. 46, no. 4, pp. 509-520, April 1998. These methods do not account for random propagation effects (e.g., path loss, shadowing and multipath fading) and are restricted to non-coherent modulations.

The article “Co-channel Interference Modeling and Analysis in a Poisson Field of Interferers in Wireless Communications,” by X. Yang and A. Petropulu, published in IEEE Trans. Signal Processing, vol. 51, no. 1, pp. 64-76, January 2003, discloses a technique that is applicable to systems synchronized at the symbol or slot level. Such synchronization restriction is typically impractical.

The article “The performance of linear multiple-antenna receivers with interferers distributed on a plane,” by S. Govindasamy, F. Antic, D. Bliss, and D. Staelin, published in Proc. IEEE Workshop on Signal Proc. Advances in Wireless Commun., June 2005, pp. 880-884, and the article “Uncoordinated rate-division multiple-access scheme for pulsed UWB signals,” by M. Weisenhorn and W. Hirt, published IEEE Trans. Veh. Technol., vol. 54, no. 5, pp. 1646-1662, September 2005, disclose an approach that restricts node locations to a disk in a two-dimensional (2-D) plane. This approach presupposes a finite number of interferers, complicates the design procedure, and does not provide a useful tool for network design.

In general, the above methods of the prior art do not account for many parameters that are important to network design, such as signal-to-noise ratio (SNR), interference-to-noise ratio (INR), path loss exponent, spatial density of the interferers, and error probability.

### SUMMARY

A wireless communication system experience interference from other wireless communication networks. A method for designing wireless communication systems subject to interference is provided based on a realistic interference model which accounts for the propagation effects introduced by the wireless environment (such as path loss, shadowing, and multipath fading), and the spatial scattering of transmitters (using a Poisson field). The method accounts for tradeoffs between network parameters, such as SNR, INR, path loss exponent, spatial density of the interferers, and error probability. Advantages of this method include: 1) a unified framework for designing a wireless system, subject to cumulative interference and noise, incorporating a wide range of performance metrics; and 2) a general application that covers a broad class of wireless communication systems and channel fading distributions.

According to one embodiment of the present invention, a method for designing a wireless network includes (a) selecting a performance parameter based on a desired quality of service; (b) incorporating a set of expected propagation channel parameters; and (c) determining a set of system parameters based on the expected propagation channel parameters and an interference constraint. The interference constraint may be computed based on a cumulative interference and may be expressed as a probability of the cumulative interference exceeding a predetermined threshold value. The cumulative interference may be computed based on a stable distribution. Alternatively, the interference constraint may be computed based on a bit error measure, which may be expressed as the probability of the bit error measure exceeding a predetermined threshold value.

A method of the present invention uses an interference constraint applicable to both narrowband and UWB sources of interference. The interference constraint may take into account spatial density of transmitters, measured interference or noise power, modulation method and bit error rate. One model for spatial density is provided by a Poisson field.

According to one embodiment of the present invention, the propagation channel parameters include one or more of path loss parameter, shadowing parameter, and fading parameter. The system parameters may include one or more of spatial density of transmitters, measured interference or noise power, modulation method and bit error rate. A method of the present invention may be applied to design synchronous and asynchronous wireless networks.

The present invention is better understood upon consideration of the detailed description below, in conjunction with the accompanying drawings.

### BRIEF DESCRIPTION OF THE DRAWINGS

FIG. 1 illustrates a spatial distribution of interferers in a network design framework, according to one embodiment of the present invention.

FIG. 2 illustrates a cumulative interference generated by a number of network transmitters, including narrow band (NB) and ultra-wide band (UWB) interferers, which may be considered spatially distributed in a 2-D Poisson field, according to one embodiment of the present invention.

FIG. 3 illustrates applying a design framework in a heterogeneous network to an NB communication link subject to NB interferers, according to one embodiment of the present invention.

FIG. 4 illustrates applying a design framework in a heterogeneous network to a UWB communication link subject to NB interferers, according to one embodiment of the present invention.

FIG. 5 illustrates applying a design framework in a heterogeneous network to an NB communication link subject to UWB interferers, in accordance with one embodiment of the present invention.

FIG. 6 illustrates applying a design framework in a heterogeneous network to a UWB communication link subject to UWB interferers, in accordance with one embodiment of the present invention.

FIG. 7 is a flow chart for designing a wireless system based on an interference outage constraint, in accordance with one embodiment of the present invention.

FIG. 8 is a flow chart for designing a wireless system based on an error probability constraint, in accordance with one embodiment of the present invention.

FIG. 9 illustrates step 900 in either of the flow charts of FIGS. 7 and 8, incorporating wireless propagation channel parameters, in accordance with one embodiment of the present invention.

FIG. 10 illustrates interference outage design mode subsystem of step 1000 of FIG. 7, in accordance with one embodiment of the present invention.

FIG. 11 illustrates error probability design mode subsystem of step 1100 of FIG. 8, in accordance with one embodiment of the present invention.

### DETAILED DESCRIPTION OF THE PREFERRED EMBODIMENTS

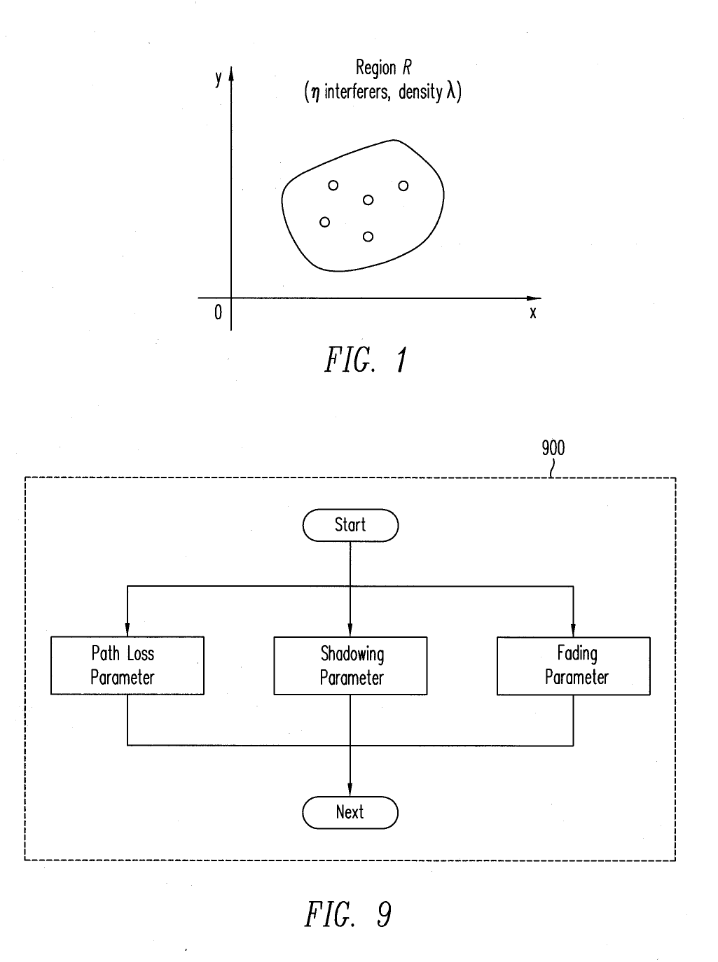

FIG. 1 illustrates a spatial distribution of transmitters in a network design framework, according to one embodiment of the present invention. As shown in FIG. 1, for example, the transmitters are distributed spatially according to a homogeneous Poisson point process in a 2-dimensional (2-D) infinite plane. Consequently, the probability of finding n interferers inside a given region R (not necessarily connected) depends only on the total area A of the region, and is given by:

$$P \{ n in R \} = \frac{{( λ A )}^{n}}{n !} {e}^{- λ A} , \qquad ( 1 )$$

where λ is a (constant) spatial density of interfering nodes, expressed in nodes per unit area. Under this model, the interfering nodes form a set of terminals that transmit within the frequency band of interest and during the time interval of interest (e.g., one symbol period). These interfering nodes therefore effectively contribute to the total interference. Regardless of the network topology (e.g., unicast, multicast, broadcast, etc.) or the multiple-access technique used (e.g., time, frequency hopping, codes, etc.), the framework of the present invention depends only on the density λ of interfering nodes.

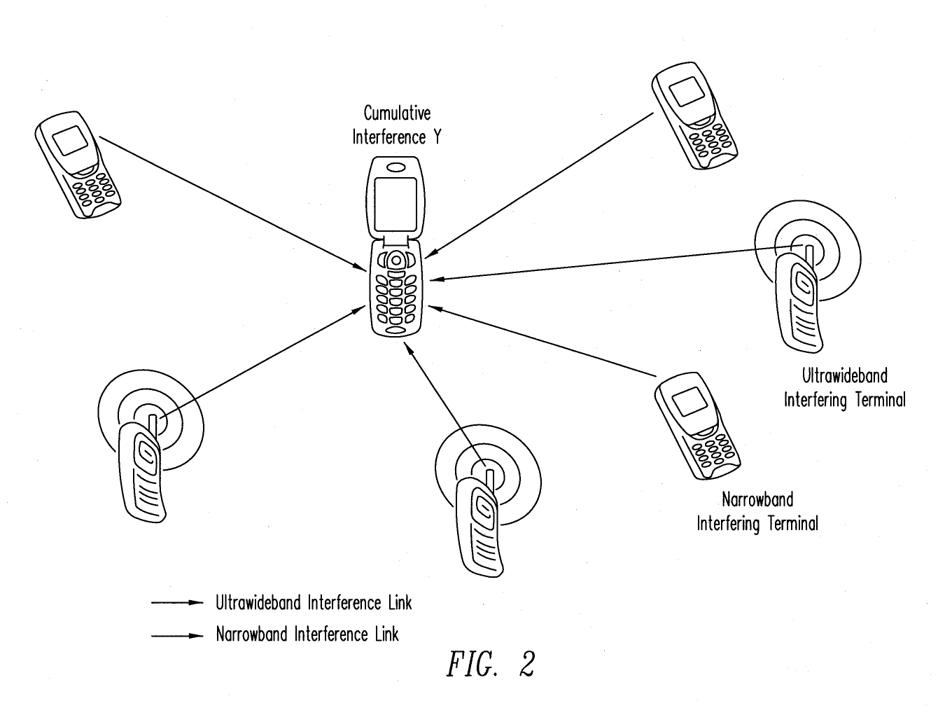

According to one embodiment of the present invention, a design method incorporates the above Poisson model is provided. FIG. 2 illustrates a cumulative interference generated by a number of network transmitters, including NB and UWB interferers, which may be considered spatially distributed in a 2-D Poisson field, according to one embodiment of the present invention. Based on the results obtained by P. C. Pinto in his Master's thesis, “Communication in a Poisson Field of Interferers,” submitted to the Department of Electrical Engineering and Computer Science, Massachusetts Institute of Technology, Cambridge, Mass., 2006 (thesis advisor, Professor Moe Z. Win), the aggregate or cumulative interference generated by all the transmitters under this model is given by the stable distribution:

$$Y ∼ S ( α = \frac{2}{b} , β = 0 , γ = {λπe}^{2 {σ}^{2} / {b}^{2}} M ( b ) ) , \qquad ( 2 )$$

where α is the characteristic exponent of the interference, β is the skewness parameter of the interference, γ is the dispersion parameter of the interference, b is the path loss exponent of the wireless propagation medium, σ is the shadowing parameter of the wireless propagation medium, and M(b) is a modulation-dependent parameter.

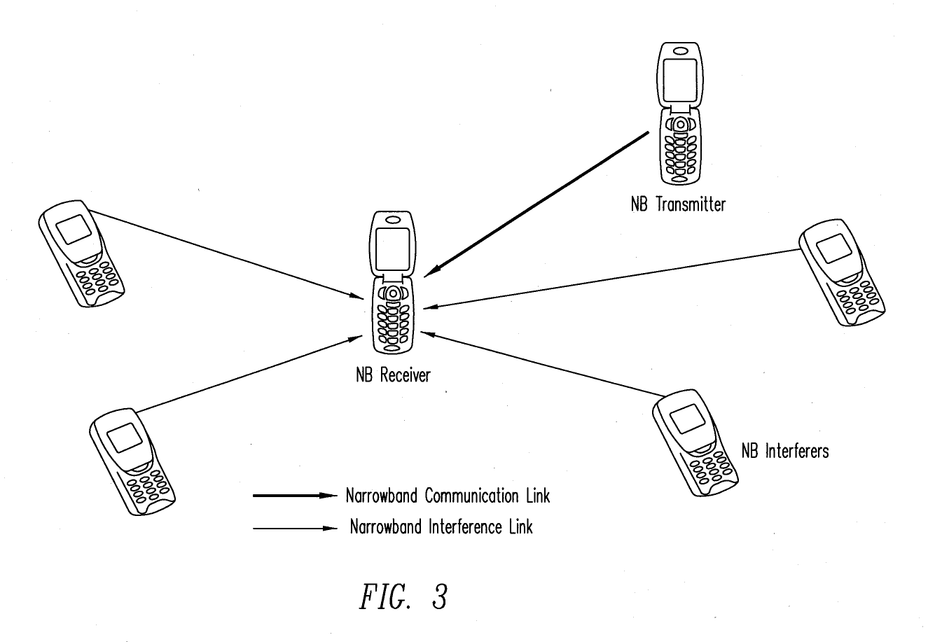

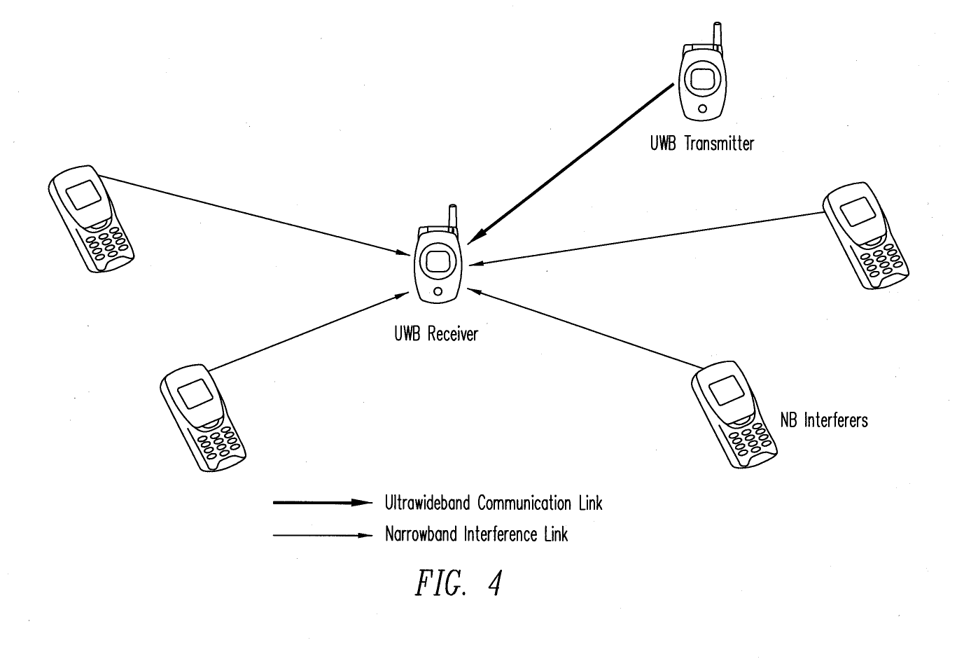

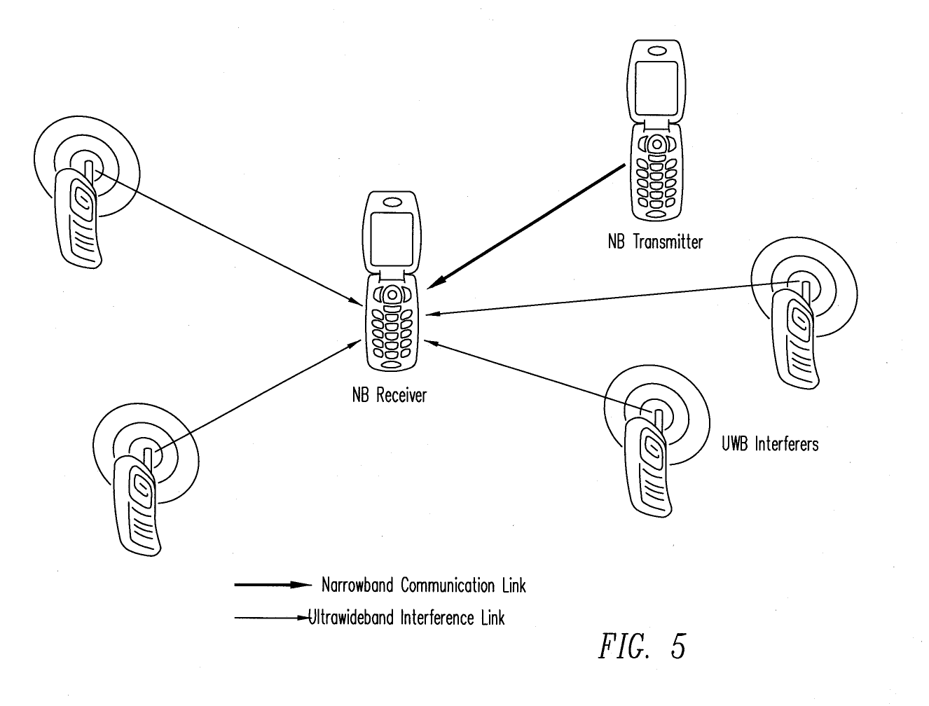

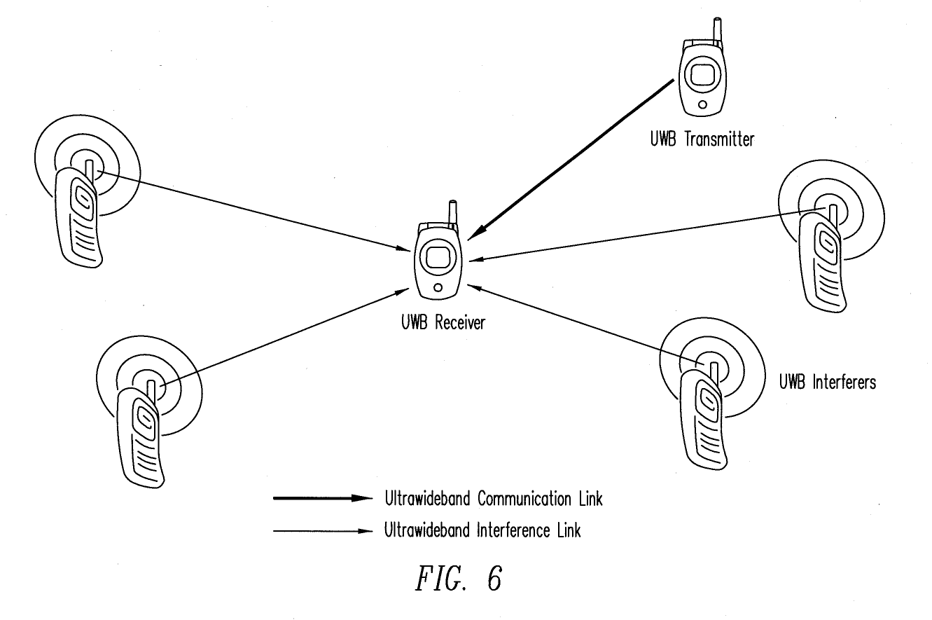

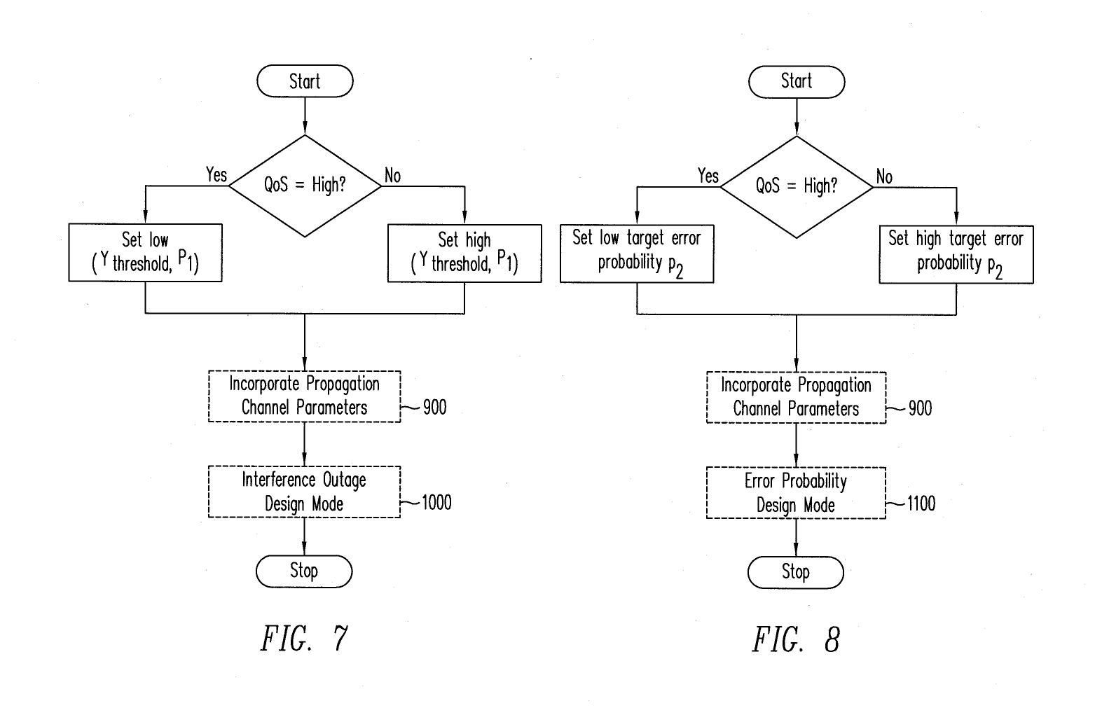

The framework of the present invention is general and can be made applicable to a large group of communication systems and propagation channels, such as NB and UWB systems, by changing the parameter M(b) appropriately. Furthermore, this model of cumulative interference is independent of the channel fading statistics (e.g., Rayleigh, Nakagami-m fading, etc.). FIGS. 3-6 illustrate four possible applications of the design framework of the present invention in a heterogeneous network to (a) an NB link subject to NB interferers (see FIG. 3); (b) an UWB link subject to NB interferers (see FIG. 4); (c) an NB link subject to UWB interferers (see FIG. 5); and (d) an UWB link subject to UWB interferers (see FIG. 6). This design framework significantly simplifies wireless network design, when interference constraints are introduced. In particular, the design framework meets design criteria “interference outage constraint” and “error probability constraint,” as illustrated by FIGS. 7-11.

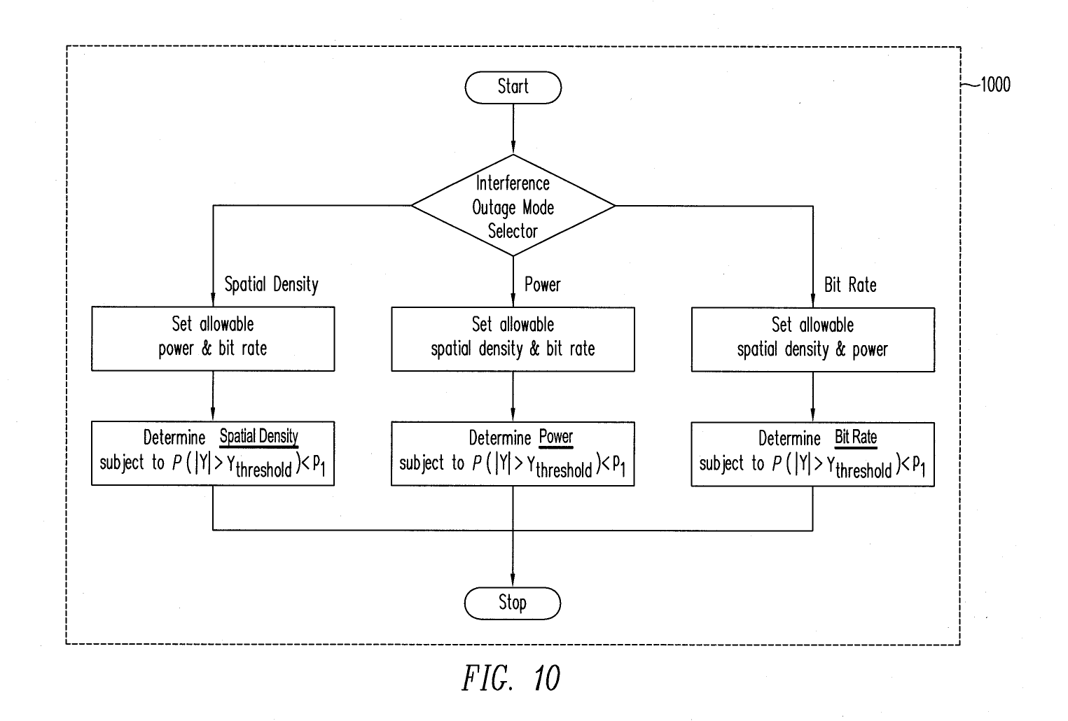

FIG. 7 provides a flow chart for designing a wireless system based on an interference outage constraint, in accordance with one embodiment of the present invention. As shown in FIG. 7, depending on a quality of service (QoS) performance value specified at the physical layer (PHY), a suitable interference threshold Y_{threshold} and a suitable probability threshold p₁ is selected. Based on the propagation channel parameters (e.g., path loss parameter, shadowing parameter, and fading parameter, as shown in FIG. 9), system parameters (e.g., node spatial density, transmitted power, bit rate, and modulation) can be calculated using equation (2) subject to the constraint that P(|Y|>Y_{threshold})<p₁. FIG. 10 shows subsystem 1000, which illustrates selecting the interference outage mode (i.e., spatial density, power, or bit rate). For example, as shown in FIG. 10, suitable spatial density values can be determined from allowable power and bit rate values, subject to the constraint p(|Y|>Y_{threshold})<p₁. Similarly, suitable power or bit rate values may be determined from the other two system parameters, subject to the same constraint P(|Y|>Y_{threshold})<p₁.

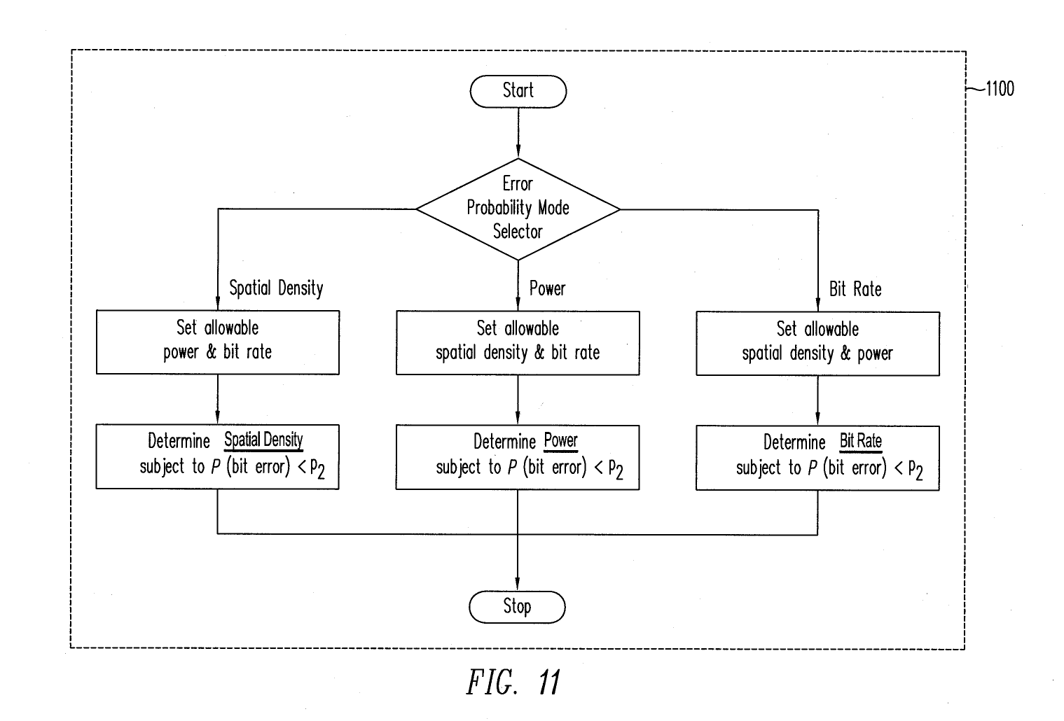

FIG. 8 provides a flow chart for designing a wireless system based on an error probability constraint, in accordance with one embodiment of the present invention. As shown in FIG. 8, depending on a QoS performance value specified at the PHY, a suitable error probability threshold p₂ is selected. Based on the system parameters (e.g., path loss parameter, shadowing parameter, and fading parameter, as shown in FIG. 9), system parameters (e.g., node spatial density, transmitted power, bit rate, and modulation) can be calculated using equation (2) subject to the constraint, for example, P(bit error)<p₂. FIG. 11 shows subsystem 1100, which illustrates selecting the error probability mode (i.e., spatial density, power, or bit rate). For example, as shown in FIG. 11, suitable spatial density values can be determined from allowable power and bit rate values, subject to the constraint P(bit error)<p₂. Similarly, suitable power or bit rate values may be determined from the other two system parameters, subject to the constraint P(bit error)<p₂.

Therefore, a method of the present invention provides a unified design method or framework that designs wireless communication systems subject to cumulative interference and noise, incorporating a wide range of design criteria. The method may cover a broad class of wireless communication systems and may possess a probabilistic invariance with respect to any fading distribution. Unlike the prior art, the design method of the present invention is founded on realistic wireless models, which account for important propagation effects such as path loss, shadowing, and multipath fading. Such a framework is tractable and insightful, establishing fundamental results that are of value to the network designer.

The detailed description above is provided to illustrate specific embodiments of the present invention and is not intended to be limiting. Numerous modifications and variations within the scope of the present invention are possible. The present invention is set forth in the following claims.

We claim:

1. A method for designing a wireless network, comprising:
selecting a performance parameter based on a desired quality of service;
incorporating a set of expected propagation channel parameters; and
determining a set of system parameters based on the expected propagation channel parameters and an interference constraint.

2. A method as in claim 1, wherein the interference constraint is computed based on cumulative interference.

3. A method as in claim 2, wherein the interference constraint is expressed as a probability of the cumulative interference exceeding a predetermined threshold value.

4. A method as in claim 2, wherein the cumulative interference is computed based on a stable distribution.

5. A method as in claim 1, wherein the interference constraint is computed based on a bit error measure.

6. A method as in claim 5, wherein the interference constraint is expressed as the probability of the bit error measure exceeding a predetermined threshold value.

7. A method as in claim 1, wherein the interference constraint incorporates both narrowband and ultra-wide band sources of interference.

8. A method as in claim 1, wherein the interference constraint incorporates one or more of spatial density of transmitters, measured interference or noise power, modulation method and bit error rate.

9. A method as in claim 8, wherein the spatial density of transmitters is modeled by a Poisson field.

10. A method as in claim 1, wherein the channel propagation parameters include one or more of path loss parameter, shadowing parameter, and fading parameter.

11. A method as in claim 1, wherein the system parameters include one or more of spatial density of transmitters, measured interference or noise power, modulation method and bit error rate.

12. A method as in claim 1, being applied to design an asynchronous wireless network.

13. A method as in claim 1, being applied to design a synchronous wireless network.
